(19) United States
(12) Patent Application Publication
(10) Pub. No.: US 2010/0146024 A1
(43) Pub. Date: Jun. 10, 2010

(54) DIGITAL FILTER, ITS SYNTHESIZING DEVICE, SYNTHESIZING PROGRAM AND SYNTHESIZING PROGRAM RECORDING MEDIUM

(76) Inventor: Kouichi Magano, Osaka (JP)

Correspondence Address: MCDERMOTT WILL & EMERY LLP, 600 13TH STREET, NW, WASHINGTON, DC, 20005-3096, US

(21) Appl. No.: 12/376,408

(22) PCT Filed: Mar. 19, 2007
(86) PCT No.: PCT/JP2007/055542

§ 371 Date: Feb. 4, 2009

(30) Foreign Application Priority Data
Aug. 8, 2006 (JP) 2006-215782

(51) Int. Cl. G06F 17/10; G06F 5/01; G06F 7/487; G06F 7/485

(52) U.S. Cl. 708/209; 708/300; 708/603

(57) ABSTRACT

In an IIR digital filter, for example, a multi-input multiplier/adder circuit is used as a component in place of a plurality of multipliers and a plurality of adders. With this omission of a plurality of multipliers and a plurality of adders, the circuit size can be reduced. Also, since the multi-input multiplier/adder circuit permits pipelining for increasing the processing speed in feedback processing, filter processing can be performed at high speed.

### TECHNICAL FIELD

The present invention relates to a digital filter used in signal processing in a variety of fields, and more particularly to an infinite impulse response (IIR) filter and a finite impulse response (FIR) filter that achieve miniaturization and speedup, and a signal processing device including feedback processing.

### BACKGROUND ART

Nowadays, an IIR digital filter is one of arithmetic units used in digital signal processing in various fields. Digital filters generally include finite impulse response (FIR) filters and infinite impulse response (IIR) filters. IIR filters can be of a lower order than FIR filters to attain equivalent characteristics and thus permit circuit miniaturization. In IIR filters, however, the number of bits for an operation must be sufficiently large.

Various patent applications have so far proposed configurations of IIR digital filters, including Patent Documents 1, 2 and 3, for example.

FIG. 14 shows an example of a conventional IIR digital filter. In FIG. 14, the reference numeral 1 denotes adder circuits, 2 multiplier circuits, and 3 delay circuits. The input signal is normally a two's-complement signal (signed).

Among several known types of configurations of IIR digital filters, FIG. 14 shows a configuration called direct form II. Also, FIG. 14 shows an example where the denominator and numerator of the transfer function thereof are of second order. The transfer function is represented by:

$$\begin{matrix}[ Equation 1 ] & \\ H ( z ) = \frac{B ( z )}{A ( z )} = \frac{b 0 + b 1 \cdot {Z}^{- 1} + b 2 \cdot {Z}^{- 2}}{1 + a 1 \cdot {Z}^{- 1} + a 2 \cdot {Z}^{- 2}} & ( 1 )\end{matrix}$$

The delay circuits 3 provide a time lag of one sample time, the multiplier circuits 2 multiply the outputs of the delay circuits 3 by coefficients, and the adder circuits 1 sum the outputs of the multiplier circuits 2.

The coefficients in the multiplier circuits 2 may be changed, to permit implementation of various types of filters (LPF, HPF, BPF and BRF).

In design of an IIR digital filter, it is necessary to consider the number of bits for an operation required to satisfy the characteristics, the stability of the feedback system and the like.

### Patent Document 1: Japanese Laid-Open Patent Publication No. 63-164606

### Patent Document 2: Japanese Laid-Open Patent Publication No. 2-166821

### Patent Document 3: Japanese Laid-Open Patent Publication No. 3-263910

### DISCLOSURE OF THE INVENTION

### Problems to be Solved by the Invention

However, in conventional digital filters such as IIR digital filters, the feedback processing requires performing a multiplication and several additions in one sample (one clock cycle). This causes a problem of preventing speedup of the circuit operation.

Another problem is that as the order of a digital filter becomes higher, the numbers of multiplier circuits and adder circuits increase and this increases the circuit scale.

To solve the above problems, an object of the present invention is providing a digital filter capable of achieving speedup of the circuit operation and reduction of the circuit scale, and a synthesizing device, synthesizing program and synthesizing program recording medium for such a digital filter.

### Means for Solving the Problems

To attain the above object, according to the present invention, a digital filter is composed of, not a plurality of multiplier circuits and a plurality of adder circuits, but one multi-input multiplier/adder circuit having the same functions as these circuits.

Specifically, the digital filter of the present invention includes: a shift register having a plurality of registers for storing data, the shift register shifting data in the plurality of registers every sample; a first multi-input multiplier/adder circuit permitting pipelining for increasing the processing speed, the first multi-input multiplier/adder circuit receiving an input signal and a plurality of output signals of the shift register, multiplying the plurality of output signals of the shift register by respective coefficients, summing all of the multiplied results and the input signal, and supplying the summed result to the shift register; a second multi-input multiplier/adder circuit permitting pipelining for increasing the processing speed, the second multi-input multiplier/adder circuit receiving a plurality of output signals of the shift register, multiplying the plurality of output signals of the shift register by respective coefficients, summing all of the multiplied results, and outputting the summed result as the output of the digital filter.

In the digital filter described above, the first multi-input multiplier/adder circuit may include: a partial product generation circuit for receiving the plurality of output signals of the shift register and multiplying the plurality of output signals of the shift register by respective coefficients to generate a plurality of partial products; and a multi-input adder circuit permitting pipelining for increasing the processing speed, the multi-input adder circuit receiving the input signal and outputs of the partial product generation circuit and summing all of the received signals.

In the digital filter described above, the second multi-input multiplier/adder circuit may include: a partial product generation circuit for receiving the plurality of output signals of the shift register and multiplying the plurality of output signals of the shift register by respective coefficients to generate a plurality of partial products; and a multi-input adder circuit permitting pipelining for increasing the processing speed, the multi-input adder circuit receiving outputs of the partial product generation circuit and summing all of the received signals.

Alternatively, the digital filter of the present invention includes: a shift register having a plurality of registers for storing data, the shift register shifting data in the plurality of registers every sample; and a first multi-input multiplier/adder circuit permitting pipelining for increasing the processing speed, the first multi-input multiplier/adder circuit receiving an input signal and a plurality of output signals of the shift register, multiplying the plurality of output signals of the shift register by respective coefficients, summing all of the multiplied results and the input signal, and outputting the summed result as the output of the digital filter.

In the digital filter described above, the first multi-input multiplier/adder circuit may include: a partial product generation circuit for receiving the plurality of output signals of the shift register and multiplying the plurality of output signals of the shift register by respective coefficients to generate a plurality of partial products; and a multi-input adder circuit permitting pipelining for increasing the processing speed, the multi-input adder circuit receiving the input signal and outputs of the partial product generation circuit and summing all of the received signals.

In the digital filter described above, the first and second multi-input multiplier/adder circuits may receive multiplication coefficients externally.

In the digital filter described above, in the shift register, the plurality of output signals may be selected based on an external control signal.

In the digital filter described above, in the shift register, the plurality of output signals may be selected based on an external control signal.

Alternatively the digital filter of the present invention includes: a shift register receiving two signals and having two groups of a plurality of registers for storing data, the shift register shifting data in the plurality of registers of each of the two groups every sample; a first multi-input multiplier/adder circuit permitting pipelining for increasing the processing speed, the first multi-input multiplier/adder circuit receiving an input signal and two groups of a plurality of output signals of the shift register, multiplying the two groups of the plurality of output signals of the shift register by respective coefficients, summing all of the multiplied results and the input signal, and outputting the summed result to the shift register as the first input, and also determining whether or not round-up is involved in rounding processing from the summed result obtained by multiplying the two groups of the plurality of output signals of the shift register by respective coefficients and summing all of the multiplied results and the input signal, and outputting the determined result to the shift register as the second input; a second multi-input multiplier/adder circuit permitting pipelining for increasing the processing speed, the second multi-input multiplier/adder circuit receiving a plurality of output signals of the shift register, multiplying the plurality of output signals of the shift register by respective coefficients, summing all of the multiplied results, and outputting the summed result as the output of the digital filter.

Alternatively, the digital filter of the present invention includes: a shift register receiving two signals and having two groups of a plurality of registers for storing data, the shift register shifting data in the plurality of registers of each of the two groups every sample; and a first multi-input multiplier/adder circuit permitting pipelining for increasing the processing speed, the first multi-input multiplier/adder circuit receiving an input signal and two groups of a plurality of output signals of the shift register, multiplying the two groups of the plurality of output signals of the shift register by respective coefficients, summing all of the multiplied results and the input signal, and outputting the summed result to the shift register as the first input, and also determining whether or not round-up is involved in rounding processing from the summed result obtained by multiplying the two groups of the plurality of output signals of the shift register by respective coefficients and summing all of the multiplied results and the input signal, and outputting the determined result to the shift register as the second input;

The digital filter described above may further include: an input control circuit for controlling the input signal based on an external input control signal so as to perform predetermined processing and outputting the controlled signal to the first multi-input multiplier/adder circuit, wherein the first multi-input multiplier/adder circuit receives multiplication coefficients externally, and the second multi-input multiplier/adder circuit also receives multiplication coefficients externally.

In the digital filter described above, the input control circuit may include: a bit shift circuit for performing bit shift processing for the input signal based on the external input control signal.

In the digital filter described above, the input control circuit may include: a plurality of bit shift circuits for performing bit shift processing of shifting the input signal by different numbers of bits; and a selector for selecting the outputs of the plurality of bit shift circuits based on the external input control signal.

The signal processing device of the present invention includes the digital filter described above.

The digital filter synthesizing device of the present invention synthesizes a digital filter from: a shift register having a plurality of registers for storing data, the shift register shifting data in the plurality of registers every sample; a first multi-input multiplier/adder circuit permitting pipelining for increasing the processing speed, the first multi-input multiplier/adder circuit receiving an input signal and a plurality of output signals of the shift register, multiplying the plurality of output signals of the shift register by respective coefficients, summing all of the multiplied results and the input signal, and supplying the summed result to the shift register; and a second multi-input multiplier/adder circuit permitting pipelining for increasing the processing speed, the second multi-input multiplier/adder circuit receiving a plurality of output signals of the shift register, multiplying the plurality of output signals of the shift register by respective coefficients, summing all of the multiplied results, and outputting the summed result as the output of the digital filter.

The digital filter synthesizing program of the present invention is a program for allowing a computer to synthesize a digital filter, including the steps of: synthesizing a shift register having a plurality of registers for storing data, the shift register shifting data in the plurality of registers every sample; synthesizing a first multi-input multiplier/adder circuit permitting pipelining for increasing the processing speed, the first multi-input multiplier/adder circuit receiving an input signal and a plurality of output signals of the shift register, multiplying the plurality of output signals of the shift register by respective coefficients, summing all of the multiplied results and the input signal, and supplying the summed result to the shift register; and synthesizing a second multi-input multiplier/adder circuit permitting pipelining for increasing the processing speed, the second multi-input multiplier/adder circuit receiving a plurality of output signals of the shift register, multiplying the plurality of output signals of the shift register by respective coefficients, summing all of the multiplied results, and outputting the summed result as the output of the digital filter.

The digital filter synthesizing program recording medium of the present invention has the digital filter synthesizing program described above stored therein.

As described above, in the digital filter of the present invention, which uses a multi-input multiplier/adder circuit as a component, the circuit size can be reduced. Moreover, since the multi-input multiplier/adder circuit permits pipelining for speedup, filter processing can be performed at high speed.

In particular, according to the present invention, since multiplication coefficients are received externally, the filter characteristics can be changed, and thus a digital filter having desired characteristics can be easily obtained.

According to the present invention, some arbitrary output signals can be selected from a plurality of output signals of the shift register. Hence, the filter characteristics can be changed, and thus a small-size, high-speed digital filter having desired characteristics can be obtained.

According to the present invention, round-up in a rounding operation is performed, not at the time of output of multi-input addition, but at the time of multi-input multiplication after feedback. Hence, a small-size digital filter with further high speed can be obtained.

According to the present invention, the input control circuit can perform given processing such as bit shifting, for example, for the input signal. Hence, even when the place of the LSB is different among multiplication coefficients inputted externally, a correct operation can be performed, and thus a desired high-accuracy digital filter can be implemented.

In the synthesizing device and synthesizing program for the digital filter and the recording medium of the synthesizing program, a small-size, high-speed digital filter as described above can be synthesized.

### EFFECT OF THE INVENTION

As described above, according to the present invention, with use of a multi-input multiplier/adder circuit as a component of a digital filter, size reduction can be achieved. Also, since pipelining for increasing the processing speed is permitted, a high-speed digital filter can be implemented.

In particular, according to the present invention, round-up in a rounding operation is performed, not at the time of output of multi-input addition, but at the time of multi-input multiplication and addition after feedback. Hence, a digital filter with further high speed can be obtained.

### BRIEF DESCRIPTION OF THE DRAWINGS

FIG. 1 is a block diagram of an IIR digital filter of Embodiment 1 of the present invention.

FIG. 2 is a block diagram showing a specific configuration of the IIR digital filter of Embodiment 1.

FIG. 3 is a view showing an example of an IIR digital filter permitting pipelining.

FIG. 4(a) is a view showing another example of an IIR digital filter is permitting pipelining, and FIG. 4(b) is a view showing a configuration altered from the configuration of FIG. 4(a) to delay the output by two samples.

FIG. 5 is a view showing yet another example of an IIR digital filter permitting pipelining

FIG. 6 is a block diagram of an alteration to the IIR digital filter of Embodiment 1 of the present invention.

FIG. 7 is a block diagram of an IIR digital filter of Embodiment 2 of the present invention.

FIG. 8 is a block diagram of an IIR digital filter of Embodiment 3 of the present invention.

FIG. 9 is a view showing an internal structure of a shift register of the IIR digital filter of Embodiment 3.

FIG. 10 is a block diagram of an IIR digital filter of Embodiment 4 of the present invention.

FIG. 11 is a block diagram of an IIR digital filter of Embodiment 5 of the present invention.

FIG. 12 is a view showing an internal structure of an input control circuit of the IIR digital filter of Embodiment 5.

FIG. 13 is a view showing an alteration to the input control circuit of the IIR digital filter of Embodiment 5.

FIG. 14 is a block diagram of a conventional IIR digital filter.

### DESCRIPTION OF REFERENCE NUMERALS

1 Adder circuit
2 Multiplier circuit
3 Delay circuit
4, 4a First multi-input multiplier/adder circuit
5 Second multi-input multiplier/adder circuit
6, 6a, 6b Shift register
7, 7a Partial product generation circuit
8 Multi-input adder circuit
9 Output selection circuit
10 Round-up circuit
11, 11a, 11b Input control circuit
12, 12a to 12N Bit shift circuit
13 Selector

### BEST MODE FOR CARRYING OUT THE INVENTION

Hereinafter, embodiments of the present invention will be described with reference to the relevant drawings.

### Embodiment 1

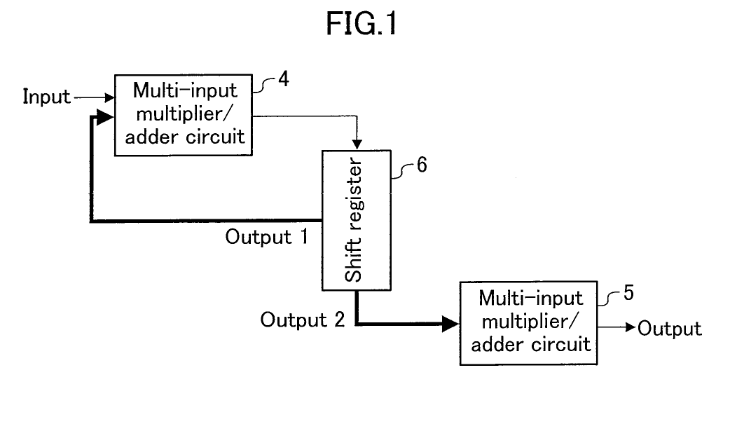

An IIR digital filter of Embodiment 1 of the present invention will be described with reference to FIGS. 1, 2, 3, 4, 5 and 6.

FIG. 1 is a block diagram of the IIR digital filter. In FIG. 1, the reference numerals 4 and 5 denote multi-input multiplier/adder circuits and 6 a shift register having a plurality of registers (not shown) therein.

The transfer function of an IIR digital filter is generally represented by:

$$\begin{matrix}[ Equation 2 ] & \\ H ( z ) = \frac{B ( z )}{A ( z )} = \frac{b 0 + b 1 \cdot {Z}^{- 1} + … + b m \cdot {Z}^{- n}}{a 0 + a 1 \cdot {Z}^{- 1} + … + a n \cdot {Z}^{- n}} & ( 2 )\end{matrix}$$

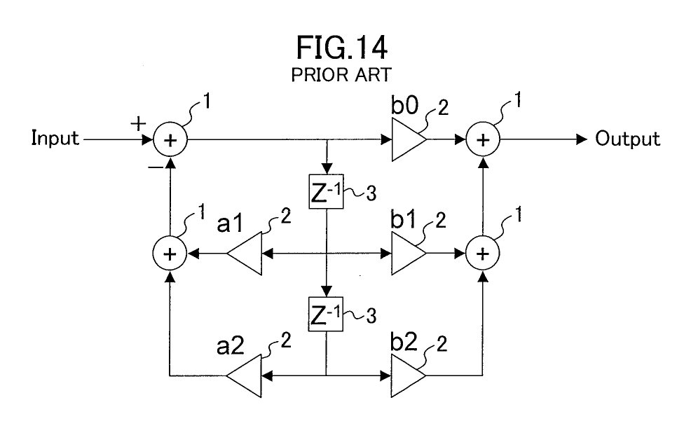

The configuration of FIG. 14, which is called direct form II, is an example where the denominator and the numerator are of second order, and the transfer function thereof is as represented by Equation 1 above.

The IIR digital filter has a feedback loop as shown in FIG. 14 in which multiplication and addition must be performed in one sample (one clock cycle). For this processing of multiplication and addition in one sample (one clock cycle), pipelining for increasing the processing speed is not permitted, and thus speedup of the circuit operation is difficult. Also, as the order of the filter is higher, the numbers of taps in the denominator and numerator of the transfer function are larger. As hardware, therefore, the numbers of multiplier circuits and adder circuits are larger, and thus reduction in circuit scale is difficult.

The IIR digital filter of FIG. 1 uses the multi-input multiplier/adder circuits 4 and 5 that permit pipelining. Hence, for a pipelining-permitting IIR digital filter, such an IIR digital filter performing multiplication and addition in two samples (one clock cycle) in a feedback loop, for example, it is possible to adopt two-stage pipelining for multi-input multiplication/addition of the multi-input multiplier/adder circuit 4 in the feedback loop, and thus increase the processing speed of the circuit.

Also, with use of the multi-input multiplier/adder circuits 4 and 5 that perform multiplications of a plurality of inputs and all additions, not using a plurality of multiplier circuits and a plurality of adder circuits as in the conventional IIR digital filter, the circuit scale can be reduced. Reduction in circuit scale can also be attained by providing only one shift register 6 for sharing.

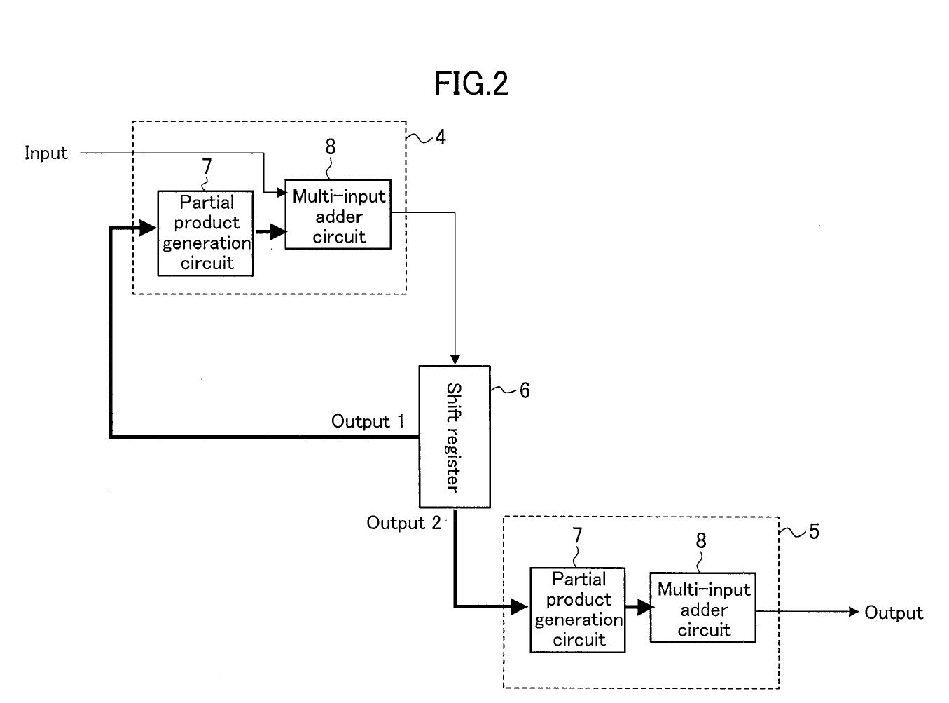

FIG. 2 is a block diagram of the IIR digital filter, showing an example of the internal configuration of the multi-input multiplier/adder circuits 4 and 5. In FIG. 2, the reference numerals 4 and 5 denote multi-input multiplier/adder circuits, 6 a shift register, 7 partial product generation circuits placed in the multi-input multiplier/adder circuits 4 and 5, and 8 multi-input adder circuits placed in the multi-input multiplier/adder circuits 4 and 5.

The partial product generation circuit 7 of each of the multi-input multiplier/adder circuits 4 and 5 multiplies a plurality of inputs by respective coefficients to generate partial products. The partial product generation circuit 7 is configured to calculate partial products by one-bit multiplication, which is equal to execution of AND in bit operation. The multi-input adder circuit 8 of each of the multi-input multiplier/adder circuits 4 and 5 is a circuit that receives a plurality of partial product results from the partial product generation circuit 7 and sums up these inputs, and may be configured of a Wallace tree adder circuit.

The multi-input multiplier/adder circuits 4 and 5 shown in FIG. 2 permit pipelining for increasing the processing speed of the circuits. Speedup can therefore be achieved. Also, since multi-input multiplication and addition are performed, the circuit scale is reduced. Hence, a small-size, high-speed IIR digital filter can be implemented.

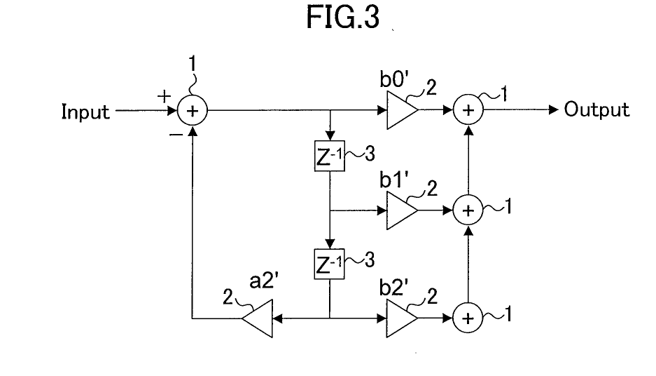

FIG. 3 is a view showing an example of an IIR digital filter permitting pipelining, configured based on the IIR digital filter of FIGS. 1 and 2. In FIG. 3, the reference numeral 1 denotes adder circuits, 2 multiplier circuits and 3 delay circuits.

The first-order transfer function of an IIR digital filter is represented by:

$$\begin{matrix}[ Equation 3 ] & \\ H ( z ) = \frac{B ( z )}{A ( z )} = \frac{b 0 + b 1 \cdot {Z}^{- 1}}{1 + a 1 \cdot {Z}^{- 1}} & ( 3 )\end{matrix}$$

The circuit of FIG. 3 is obtained by multiplying the denominator and numerator of Equation 3 representing the first-order transfer function of an IIR digital filter by:

[Equation 4]

1−a1·Z⁻¹ (4)

The resultant transfer function is represented by

$$\begin{matrix}H ( z ) = \frac{{B}^{′} ( z )}{{A}^{′} ( z )} \\ = \frac{b 0 + b 1 \cdot {Z}^{- 1}}{1 + a 1 \cdot {Z}^{- 1}} \cdot \frac{1 - a 1 \cdot {Z}^{- 1}}{1 - a 1 \cdot {Z}^{- 1}} \\ = \frac{b 0 + ( b 1 - b 0 \cdot a 1 ) \cdot {Z}^{- 1} + b 1 \cdot a 1 ) \cdot {Z}^{- 2}}{1 - a {1}^{2} \cdot {Z}^{- 2}} \\ = \frac{b {0}^{′} + b {1}^{′} \cdot {Z}^{- 1} + b {2}^{′} \cdot {Z}^{- 2}}{1 + a {2}^{′} \cdot {Z}^{- 2}}\end{matrix} \qquad ( 5 )$$

The expression of the denominator of the above transfer function has a term of Z⁻² and no more has the term of Z⁻¹. This indicates that two-stage pipelining can be adopted for multiplication and addition in the feedback loop. The processing speed can therefore be increased.

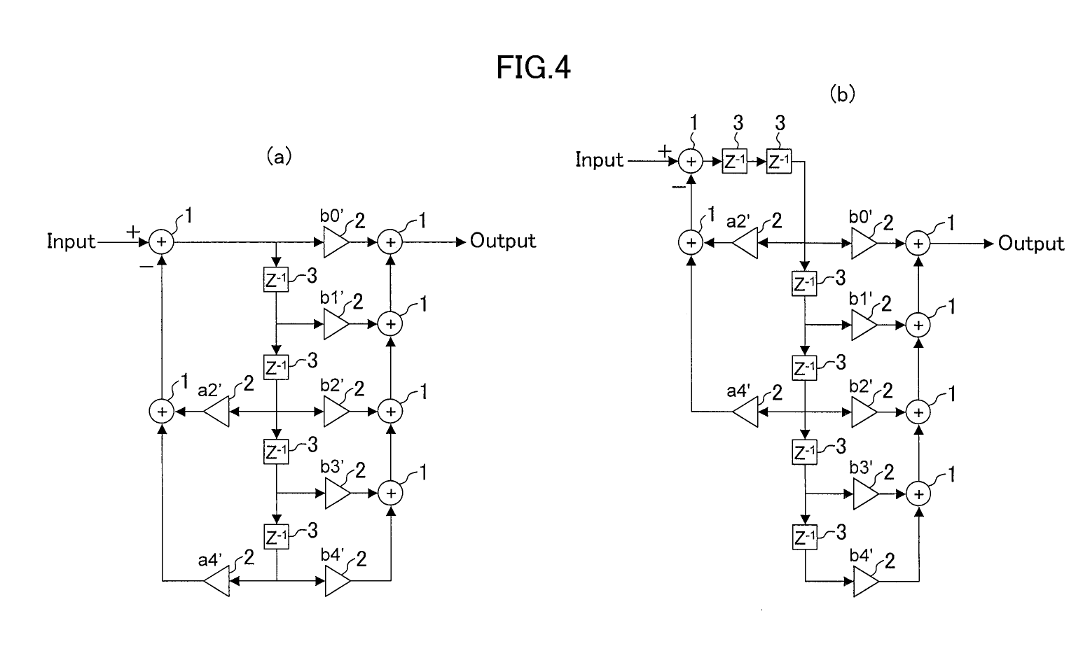

FIG. 4(a) is a view showing another example of an IIR digital filter permitting pipelining. In FIG. 4(a), the reference numeral 1 denotes adder circuits, 2 multiplier circuits and 3 delay circuits. FIG. 4(b) shows an IIR digital filter in which the output in FIG. 4(a) is delayed by two samples (by two delay circuits 3).

The circuit of FIG. 4(a) is obtained by multiplying the denominator and numerator of Equation (1) representing the transfer function of the conventional IIR digital filter of FIG. 14 by:

[Equation 6]

1−a1·Z⁻¹+a2·Z⁻² (6)

The resultant transfer function is represented by

$$\begin{matrix}H ( z ) = \frac{{B}^{′} ( z )}{{A}^{′} ( z )} \\ = \frac{b 0 + b 1 \cdot {Z}^{- 1} + b 2 \cdot {Z}^{- 2}}{1 + a 1 \cdot {Z}^{- 1} + a 2 \cdot {Z}^{- 2}} \cdot \frac{1 - a 1 \cdot {Z}^{- 1} + a 2 \cdot {Z}^{- 2}}{1 - a 1 \cdot {Z}^{- 1} + a 2 \cdot {Z}^{- 2}} \\ = \frac{\begin{matrix}b 0 + ( b 1 - a 1 \cdot b 0 ) {Z}^{- 1} + ( b 2 - a 1 \cdot b 1 + a 2 \cdot b 0 ) {Z}^{- 2} + \\ ( a 1 \cdot b 2 + a 2 \cdot b 1 ) {Z}^{- 3} + a 2 \cdot b 2 \cdot {Z}^{- 4}\end{matrix}}{1 + ( 2 \cdot a 2 - a {1}^{2} ) {z}^{- 2} + a {2}^{2} \cdot {Z}^{- 4}} \\ = \frac{b {0}^{′} + b {1}^{′} \cdot {Z}^{- 1} + b {2}^{′} \cdot {Z}^{- 2} + b {3}^{′} \cdot {Z}^{- 3} + b {4}^{′} \cdot {Z}^{- 4}}{1 + a {2}^{′} \cdot {Z}^{- 2} + a {4}^{′} \cdot {Z}^{- 4}}\end{matrix} \qquad ( 7 )$$

The expression of the denominator of the above transfer function no more has the term of Z⁻¹ and has a term of Z⁻². This indicates that two-stage pipelining can be adopted for multiplication and addition in the feedback loop. The processing speed can therefore be increased.

The IIR digital filters of FIGS. 3 and 4 may be obtained, not by conversion of equations, but by directly computing (approximating) coefficients with which the transfer functions of Equations (5) and (7) are given.

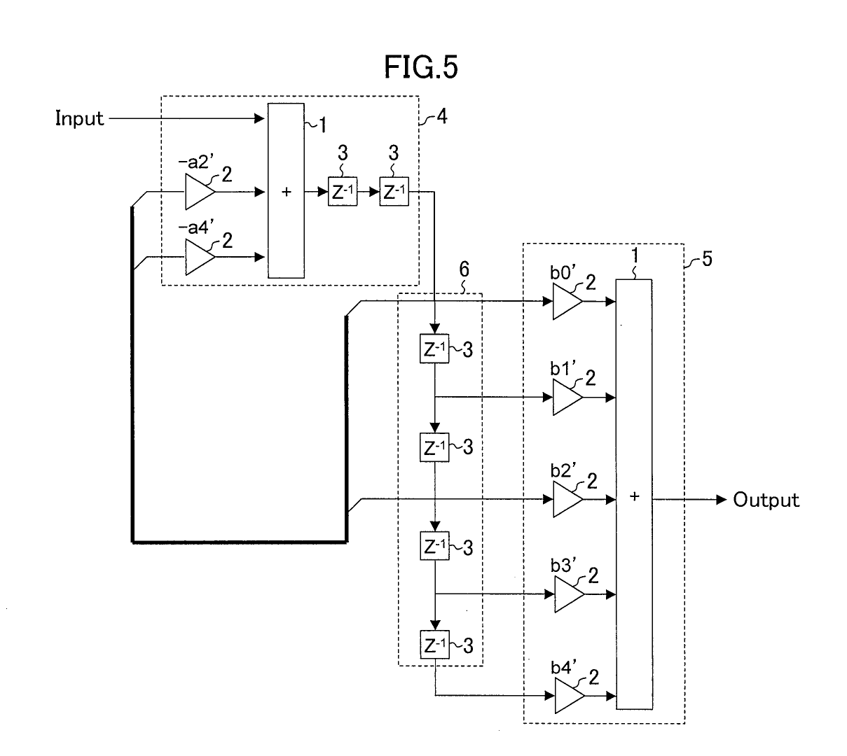

FIG. 5 is a view showing another example of an IIR digital filter permitting pipelining. In FIG. 5, the reference numeral 1 denotes adder circuits, 2 multiplier circuits and 3 delay circuits.

The IIR digital filter of FIG. 5, which is identical in configuration to the circuit of FIG. 4(b), is grouped into blocks of the multi-input multiplier/adder circuits 4 and 5 and the shift register 6 shown in FIG. 1. With this configuration, pipelining for increasing the processing speed can be adopted for the multiplication and addition in the feedback loop.

Although the multi-input multiplier/adder circuit 5 shown in FIG. 5 is composed of five multipliers 2 and one adder 1, the internal configuration thereof may be composed of the partial product generation circuit 7 and the multi-input adder circuit 8 shown in FIG. 2.

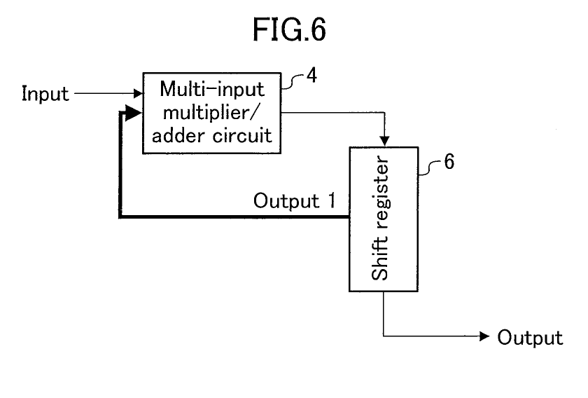

FIG. 6 is a block diagram of another IIR digital filter. In FIG. 6, the reference numeral 4 denotes a multi-input multiplier/adder circuit and 6 a shift register.

The IIR digital filter of FIG. 6 has a configuration omitting the second multi-input multiplier/adder circuit 5 from the configuration of FIG. 1, which is therefore responsible for only feedback processing and is composed of only the denominator term of the transfer function.

The IIR digital filter of FIG. 6 uses the multi-input multiplier/adder circuit 4 permitting pipelining, and thus the processing speed of the circuit can be increased. Also, with use of the multi-input multiplier/adder circuit 4 that performs multiplication and addition with a plurality of inputs, not using a plurality of multiplier circuits and a plurality of adder circuits as in the conventional IIR digital filter, the circuit scale can be reduced.

The IIR digital filters described in this embodiment can be used for digital signal processing devices in a variety of fields.

The IIR digital filters were described in this embodiment. It is however needless to mention that the present invention is applicable to FIR digital filters and other filters including feedback processing and also usable for other signal processing devices.

Thus, in this embodiment, with use of the multi-input multiplier/adder circuit, the circuit size can be reduced, and also pipelining for speedup can be adopted. Hence, a small-size, high-speed IIR digital filter can be implemented.

### Embodiment 2

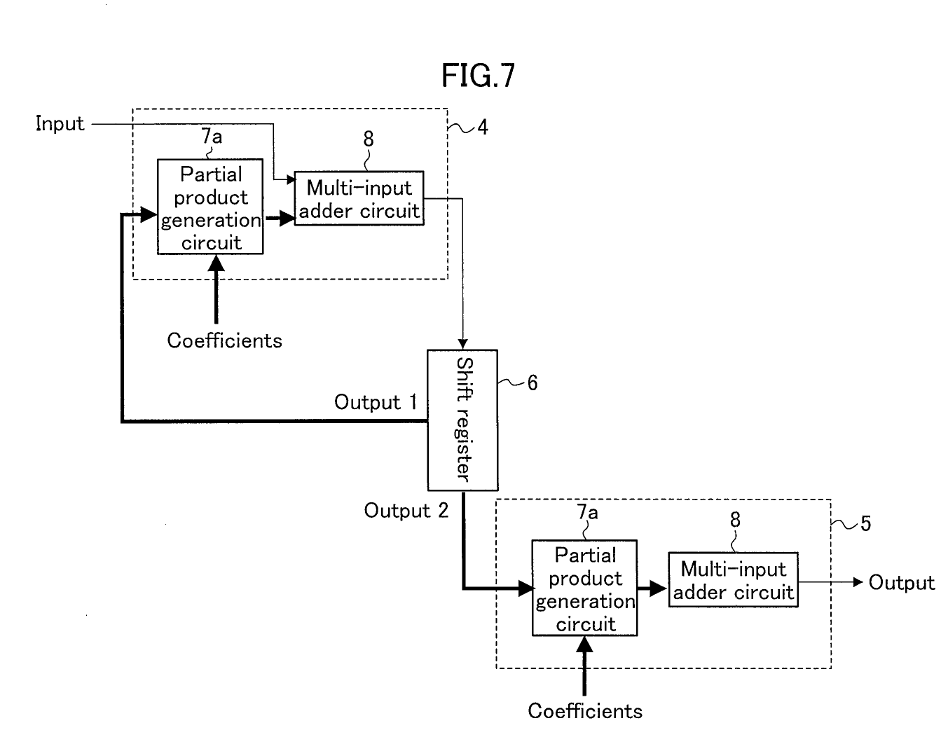

Next, an IIR digital filter of Embodiment 2 of the present invention will be described with reference to FIG. 7.

FIG. 7 is a block diagram of the IIR digital filter. In FIG. 7, the reference numerals 4 and 5 denote multi-input multiplier/adder circuits, 6 a shift register, 7a partial product generation circuits and 8 multi-input adder circuits.

The basic circuit configuration of FIG. 7 is the same as that of FIG. 2 in Embodiment 1 except that coefficients for multiplication in the partial product generation circuits 7a can be supplied externally. With this capability of external supply of coefficients for multiplication, the characteristics of the filter can be changed to desired ones.

In addition, the multi-input multiplier/adder circuits 4 and 5 shown in FIG. 7 permit pipelining for increasing the circuit processing speed. Also, with the multi-input multiplication and addition, the circuit scale can be reduced. This makes it possible to attain a small-size, high-speed IIR digital filter.

With the above configuration, the characteristics of the filter can be changed to desired ones. Also, with use of the multi-input multiplier/adder circuits, the circuit size can be reduced, and pipelining for speedup can be adopted. Hence, a small-size high-speed IIR digital filter can be implemented.

### Embodiment 3

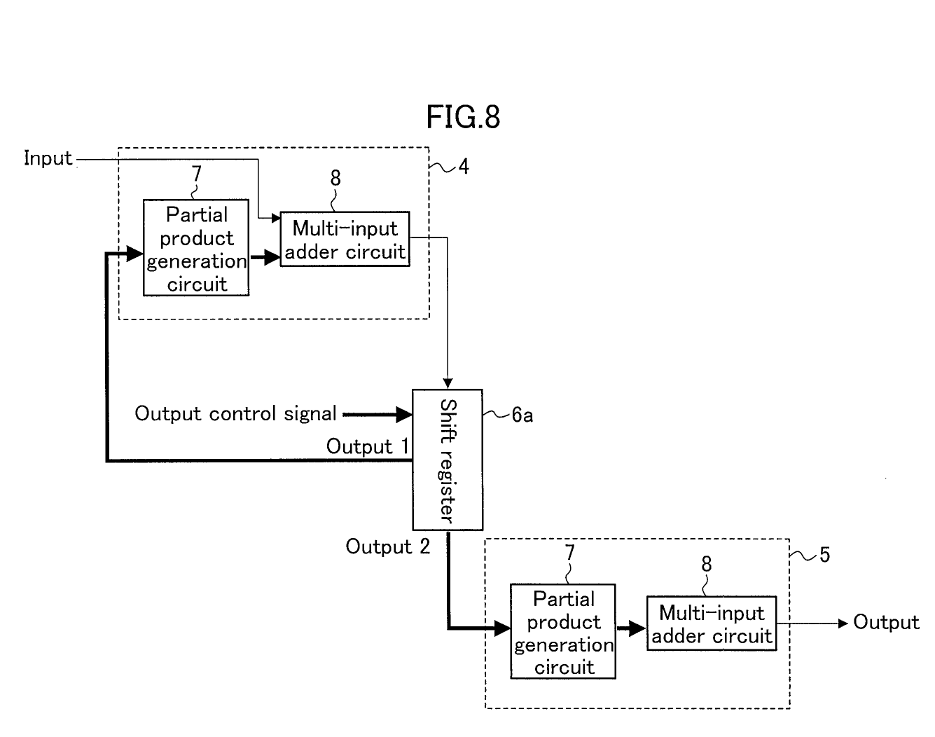

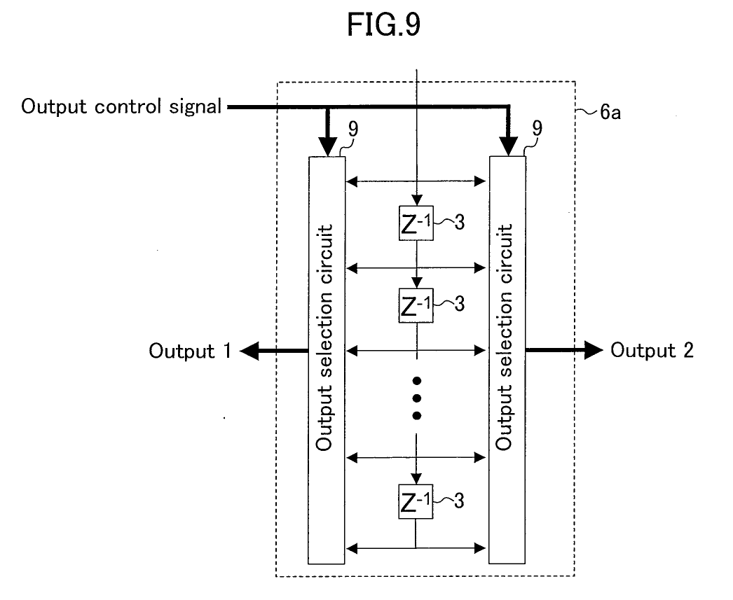

An IIR digital filter of Embodiment 3 of the present invention will be described with reference to FIGS. 8 and 9.

FIG. 8 is a block diagram of the IIR digital filter. In FIG. 8, the reference numerals 4 and 5 denote multi-input multiplier/adder circuits, 6a a shift register, 7 partial product generation circuits and 8 multi-input adder circuits.

The basic circuit configuration of FIG. 8 is the same as that of FIG. 2 in Embodiment 1 except that the combination of a plurality of outputs constituting each of two groups of output from the shift register 6a is made controllable externally.

In this embodiment, with the capability of external control of the combination of outputs of each group from the shift register 6a, the characteristics of the filter can be changed to desirable ones.

Also, with the capability of control of the combination of outputs of each group from the shift register 6a, the circuit configuration can be changed to one permitting pipelining for increasing the circuit processing speed.

FIG. 9 is a view showing an internal configuration of the shift register 6a. In FIG. 9, the reference numeral 3 denotes delay circuits, 6a a shift register and 9 output selection circuits.

The shift register 6a receives the output of the multi-input multiplier/adder circuit 4 shown in FIG. 8 and an external output control signal, and outputs two groups of output signals. One group of output signals serve as inputs of the multi-input multiplier/adder circuit 4 for calculation of the denominator term of the transfer function, while the other group of output signals serve as inputs of the multi-input multiplier/adder circuit 5 for calculation of the numerator term of the transfer function. Each of the two output selection circuits 9 provided in the shift register 6a selects some output signals from the outputs of the plurality of delay circuits 3 according to the external output signal, and outputs the selected ones.

With the above configuration, with use of the multi-input multiplier/adder circuits 4 and 5, the circuit size can be reduced, and also pipelining for speedup can be adopted. Hence, a small-size, high-speed IIR digital filter can be implemented.

### Embodiment 4

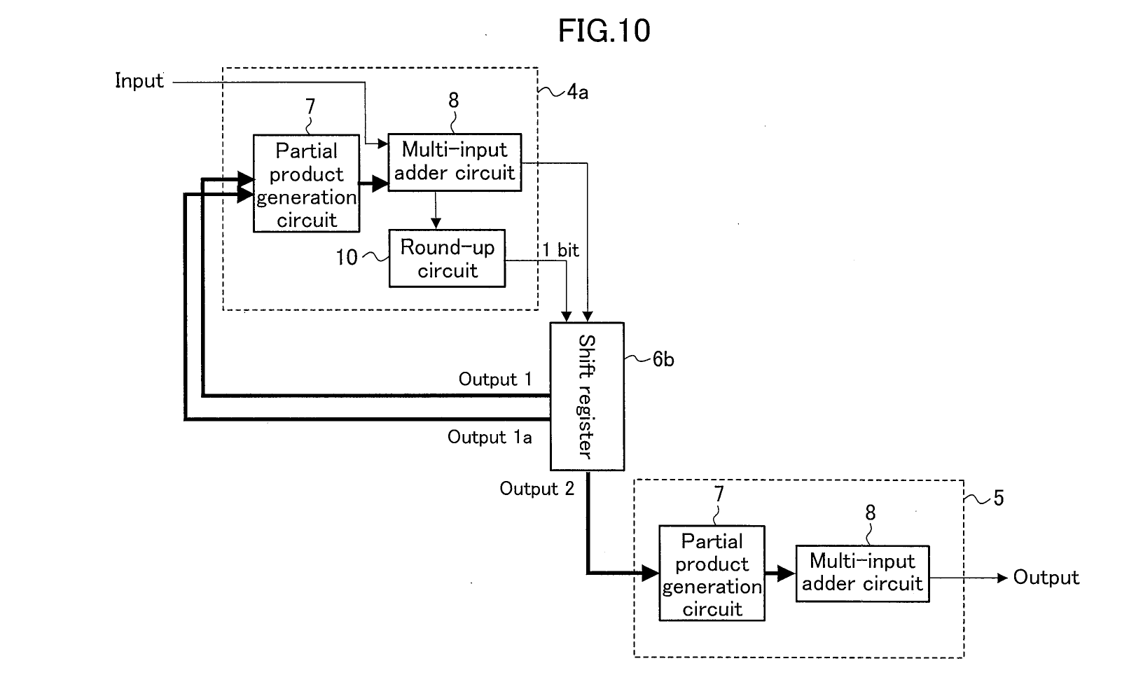

An IIR digital filter of Embodiment 4 of the present invention will be described with reference to FIG. 10.

FIG. 10 is a block diagram of the IIR digital filter. In FIG. 10, the reference numerals 4a and 5 denote multi-input multiplier/adder circuits, 6b a shift register, 7 partial product generation circuits, 8 multi-input adder circuits and 10 a round-up circuit.

In the feedback processing for calculation of the denominator term of the transfer function of the IIR digital filter, processing of cutting a low-order bit is normally necessary in the addition at the final stage. For this processing, various rounding methods such as round-down, round-up and round-off are adopted. When round-up (adding 1) is involved in rounding processing, the operation time for the rounding processing will be long if the round-up is necessary after addition at the final stage. Since round-up is processing of adding 1 (one increment), involving carrying from a low-order bit toward a higher-order bit, the operation time will be long.

The IIR digital filter of FIG. 10 performs round-up at the time of generation of a partial product by the partial product generation circuit 7 of the multi-input multiplier/adder circuit 4a simultaneously, not after addition at the final stage. This can make the round-up operation time shorter than when round-up is performed after addition at the final stage.

In FIG. 10, the round-up circuit 10 of the multi-input multiplier/adder circuit 4a determines whether or not round-up is involved in rounding processing from the output of the multi-input adder circuit 8, and outputs 1 if round-up is involved or 0 if not. While the shift register 6 in FIG. 1 receives the output of the multi-input adder circuit 8 of the multi-input multiplier/adder circuit 4, the shift register 6b receives the outputs of the multi-input adder circuit 8 and the round-up circuit 10 of the multi-input multiplier/adder circuit 4a as the first and second inputs, respectively. The two input signals are shifted inside the shift register 6b at the same timing and outputted as two groups of a plurality of output signals at the same output timing, to be inputted into the partial product generation circuit 7 of the multi-input multiplier/adder circuit 4a. The plurality of input signals for round-up, out of the two groups of input signals at the partial product generation circuit 7 are multiplied by corresponding multiplication coefficients to generate partial products for round-up.

In this embodiment, although the number of partial products increases compared with the IIR digital filter of Embodiment 1, the round-up processing involves no carrying. Hence, the operation time can be made shorter than when round-up for rounding processing is performed after addition at the final stage.

In the IIR digital filter of FIG. 10, rounding processing is performed only in the is feedback loop, but is not performed for the output to the multi-input multiplier/adder circuit 5. This may be effective in terms of shortening the operation time.

With the above configuration, the round-up operation time can be shortened. Moreover, as already described, with the multi-input multiplier/adder circuits 4a and 5, the circuit size can be reduced, and pipelining for speedup can be adopted. Hence, a small-size, high-speed IIR digital filter can be implemented.

### Embodiment 5

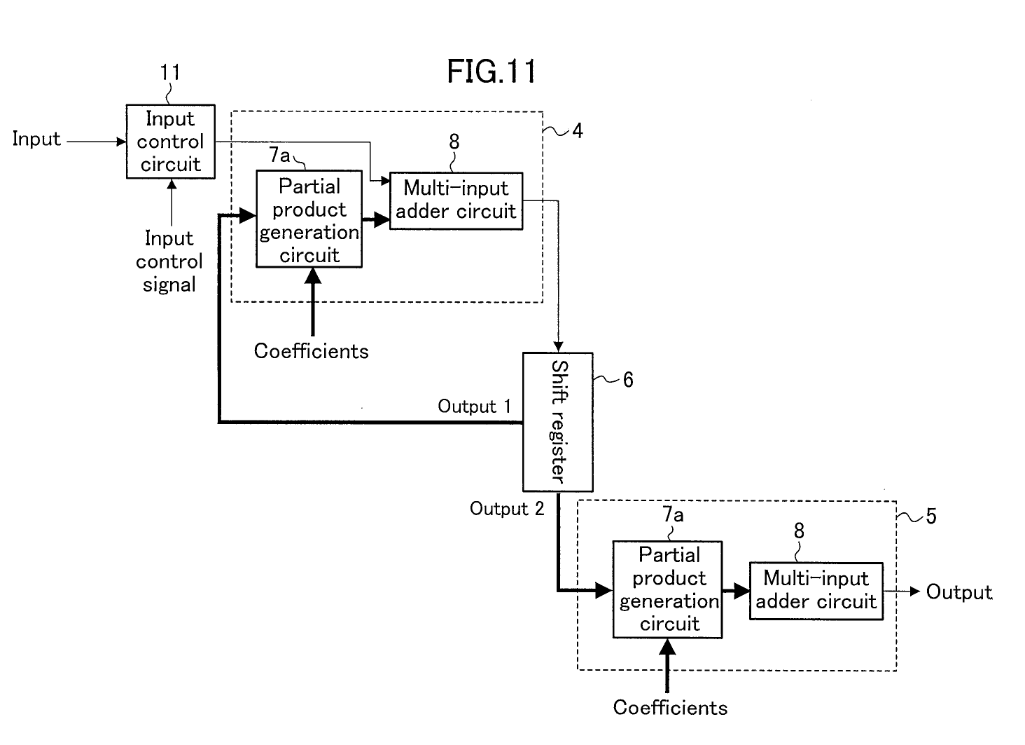

An IIR digital filter of Embodiment 5 of the present invention will be described with reference to FIGS. 11, 12 and 13.

FIG. 11 is a block diagram of the IIR digital filter. In FIG. 11, the reference numerals 4 and 5 denote multi-input multiplier/adder circuits, 6 a shift register, 7a partial product generation circuits, 8 multi-input adder circuits and 11 an input control circuit.

The basic circuit confirmation of FIG. 11 is the same as that of FIG. 2 in Embodiment 1 except that the input signal can be controlled using the input control circuit 11 with an external input control signal and that coefficients for multiplication in the partial product generation circuits 7a can be supplied externally.

With the capability of external supply of coefficients for multiplication, the characteristics of the filter can be changed to desired ones.

In the external supply of coefficients for multiplication, if the position of the fixed decimal point is different among coefficients, the place of the least significant bit (LSB) will be different among the coefficients when the bit width of the coefficients is fixed. In this case, a correct operation will not be performed with a configuration like that in FIG. 2 where the place (of the LSB) of the input signal is fixed. To solve this problem, in this embodiment, the place (of the LSB) of the input signal is controlled with the input control circuit 11 in FIG. 11, to permit a correct operation.

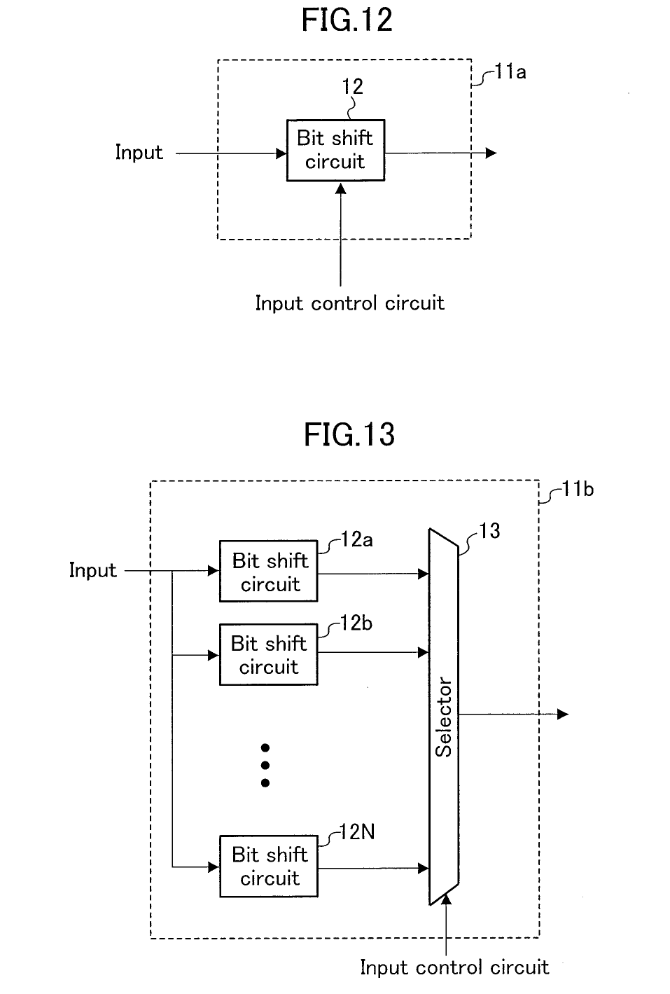

FIG. 12 is a view showing an example of the internal configuration of the input control circuit 11 in FIG. 11. In FIG. 12, the reference numeral 11a denotes an input control circuit and 12 a bit shift circuit. The amount of bit shift in the bit shift circuit 12 is controlled with the external input control signal. The bit shift amount is an amount corresponding to the place of the LSB of the coefficients for the partial product generation circuit 7a in FIG. 11.

FIG. 13 is a view showing another example of the internal configuration of the input control circuit 11 in FIG. 11. In FIG. 13, the reference numeral 11b denotes an input control circuit, 12a, 12b, 12N a plurality of bit shift circuits and 13 a selector.

The plurality of bit shift circuits 12a, 12b, 12N are circuits for bit-shifting the input signal by respective bit shift amounts. The bit shift amounts are amounts corresponding to the places of the LSBs of various coefficients inputted into the partial product generation circuit 7a in FIG. 11. The selector 13 selects a bit shift output from a bit shift circuit, among the plurality of bit shift circuits 12a, 12b, 12N, which is set at a bit shift amount corresponding to the place of the LSB of the actual coefficient inputted into the partial product circuit 7a according to the external input control signal.

With the above configuration, the characteristics of the filter can be changed to desirable ones. Moreover, as already described, with the multi-input multiplier/adder circuits, the circuit size can be reduced, and pipelining for speedup can be adopted. Hence, a small-size, high-speed IIR digital filter can be implemented.

While the configuration of the IIR digital filter was discussed above, the present invention also includes a synthesizing device for synthesizing an IIR digital filter having such a configuration. Moreover, the present invention includes, not only the IIR digital filter physically having such a configuration, but also a digital filter synthesizing program for generating such a configuration and a recording medium having such a synthesizing program recorded thereon.

### INDUSTRIAL APPLICABILITY

As described above, the digital filter of the present invention, which uses a multi-input multiplier/adder circuit permitting pipelining, can achieve size reduction and speedup. Hence, the inventive digital filter is usable as an IIR digital filter, for example, in various types of digital signal processing, and is applicable to optical information recording devices, communication and other uses, and arithmetic devices for all types of digital signal processing.

1. A digital filter comprising:
a shift register having a plurality of registers for storing data, the shift register shifting data in the plurality of registers every sample;
a first multi-input multiplier/adder circuit permitting pipelining for increasing the processing speed, the first multi-input multiplier/adder circuit receiving an input signal and a plurality of output signals of the shift register, multiplying the plurality of output signals of the shift register by respective coefficients, summing all of the multiplied results and the input signal, and supplying the summed result to the shift register;
a second multi-input multiplier/adder circuit permitting pipelining for increasing the processing speed, the second multi-input multiplier/adder circuit receiving a plurality of output signals of the shift register, multiplying the plurality of output signals of the shift register by respective coefficients, summing all of the multiplied results, and outputting the summed result as the output of the digital filter.

2. The digital filter of claim 1, wherein the first multi-input multiplier/adder circuit comprises:
a partial product generation circuit for receiving the plurality of output signals of the shift register and multiplying the plurality of output signals of the shift register by respective coefficients to generate a plurality of partial products; and
a multi-input adder circuit permitting pipelining for increasing the processing speed, the multi-input adder circuit receiving the input signal and outputs of the partial product generation circuit and summing all of the received signals.

3. The digital filter of claim 1, wherein the second multi-input multiplier/adder circuit comprises:
a partial product generation circuit for receiving the plurality of output signals of the shift register and multiplying the plurality of output signals of the shift register by respective coefficients to generate a plurality of partial products; and
a multi-input adder circuit permitting pipelining for increasing the processing speed, the multi-input adder circuit receiving outputs of the partial product generation circuit and summing all of the received signals.

4. A digital filter comprising:
a shift register having a plurality of registers for storing data, the shift register shifting data in the plurality of registers every sample; and
a first multi-input multiplier/adder circuit permitting pipelining for increasing the processing speed, the first multi-input multiplier/adder circuit receiving an input signal and a plurality of output signals of the shift register, multiplying the plurality of output signals of the shift register by respective coefficients, summing all of the multiplied results and the input signal, and outputting the summed result as the output of the digital filter.

5. The digital filter of claim 4, wherein the first multi-input multiplier/adder circuit comprises:
a partial product generation circuit for receiving the plurality of output signals of the shift register and multiplying the plurality of output signals of the shift register by respective coefficients to generate a plurality of partial products; and
a multi-input adder circuit permitting pipelining for increasing the processing speed, the multi-input adder circuit receiving the input signal and outputs of the partial product generation circuit and summing all of the received signals.

6. The digital filter of claim 1, wherein the first and second multi-input multiplier/adder circuits receive multiplication coefficients externally.

7. The digital filter of claim 1, wherein in the shift register, the plurality of output signals are selected based on an external control signal.

8. The digital filter of claim 4, wherein in the shift register, the plurality of output signals are selected based on an external control signal.

9. A digital filter comprising:
a shift register receiving two signals and having two groups of a plurality of registers for storing data, the shift register shifting data in the plurality of registers of each of the two groups every sample;
a first multi-input multiplier/adder circuit permitting pipelining for increasing the processing speed, the first multi-input multiplier/adder circuit receiving an input signal and two groups of a plurality of output signals of the shift register, multiplying the two groups of the plurality of output signals of the shift register by respective coefficients, summing all of the multiplied results and the input signal, and outputting the summed result to the shift register as the first input, and also determining whether or not round-up is involved in rounding processing from the summed result obtained by multiplying the two groups of the plurality of output signals of the shift register by respective coefficients and summing all of the multiplied results and the input signal, and outputting the determined result to the shift register as the second input;
a second multi-input multiplier/adder circuit permitting pipelining for increasing the processing speed, the second multi-input multiplier/adder circuit receiving a plurality of output signals of the shift register, multiplying the plurality of output signals of the shift register by respective coefficients, summing all of the multiplied results, and outputting the summed result as the output of the digital filter.

10. A digital filter comprising:
a shift register receiving two signals and having two groups of a plurality of registers for storing data, the shift register shifting data in the plurality of registers of each of the two groups every sample; and
a first multi-input multiplier/adder circuit permitting pipelining for increasing the processing speed, the first multi-input multiplier/adder circuit receiving an input signal and two groups of a plurality of output signals of the shift register, multiplying the two groups of the plurality of output signals of the shift register by respective coefficients, summing all of the multiplied results and the input signal, and outputting the summed result to the shift register as the first input, and also determining whether or not round-up is involved in rounding processing from the summed result obtained by multiplying the two groups of the plurality of output signals of the shift register by respective coefficients and summing all of the multiplied results and the input signal, and outputting the determined result to the shift register as the second input;

11. The digital filter of claim 1, further comprising:
an input control circuit for controlling the input signal based on an external input control signal so as to perform predetermined processing and outputting the controlled signal to the first multi-input multiplier/adder circuit,
wherein the first multi-input multiplier/adder circuit receives multiplication coefficients externally, and
the second multi-input multiplier/adder circuit also receives multiplication coefficients externally.

12. The digital filter of claim 11, wherein the input control circuit comprises:
a bit shift circuit for performing bit shift processing for the input signal based on the external input control signal.

13. The digital filter of claim 11, wherein the input control circuit comprises:
a plurality of bit shift circuits for performing bit shift processing of shifting the input signal by different numbers of bits; and
a selector for selecting the outputs of the plurality of bit shift circuits based on the external input control signal.

14. A signal processing device comprising the digital filter of claim 1.

15. A digital filter synthesizing device for synthesizing a digital filter from:
a shift register having a plurality of registers for storing data, the shift register shifting data in the plurality of registers every sample;
a first multi-input multiplier/adder circuit permitting pipelining for increasing the processing speed, the first multi-input multiplier/adder circuit receiving an input signal and a plurality of output signals of the shift register, multiplying the plurality of output signals of the shift register by respective coefficients, summing all of the multiplied results and the input signal, and supplying the summed result to the shift register; and
a second multi-input multiplier/adder circuit permitting pipelining for increasing the processing speed, the second multi-input multiplier/adder circuit receiving a plurality of output signals of the shift register, multiplying the plurality of output signals of the shift register by respective coefficients, summing all of the multiplied results, and outputting the summed result as the output of the digital filter.

16. A digital filter synthesizing program for allowing a computer to synthesize a digital filter, comprising the steps of:
synthesizing a shift register having a plurality of registers for storing data, the shift register shifting data in the plurality of registers every sample;
synthesizing a first multi-input multiplier/adder circuit permitting pipelining for increasing the processing speed, the first multi-input multiplier/adder circuit receiving an input signal and a plurality of output signals of the shift register, multiplying the plurality of output signals of the shift register by respective coefficients, summing all of the multiplied results and the input signal, and supplying the summed result to the shift register; and
synthesizing a second multi-input multiplier/adder circuit permitting pipelining for increasing the processing speed, the second multi-input multiplier/adder circuit receiving a plurality of output signals of the shift register, multiplying the plurality of output signals of the shift register by respective coefficients, summing all of the multiplied results, and outputting the summed result as the output of the digital filter.

17. A digital filter synthesizing program recording medium having the digital filter synthesizing program of claim 16 stored therein.
